(19) United States
(12) Patent Application Publication
(10) Pub. No.: US 2016/0213958 A1
(43) Pub. Date: Jul. 28, 2016

(54) Shooting Mask

(71) Applicant: Ryan Vinh Nguyen, Oakville (CA)

(72) Inventor: Ryan Vinh Nguyen, Oakville (CA)

(21) Appl. No.: 14/606,121

(22) Filed: Jan. 27, 2015

(51) Int. Cl. A62B 23/02; A62B 18/10; A62B 18/08; A62B 18/02

(52) U.S. Cl. CPC A62B 23/025; A62B 18/02; A62B 18/10; A62B 18/084

(57) ABSTRACT

A breathing mask for a shooter is disclosed. The mask includes a housing dimensioned to fit over the user's nose and mouth with a peripheral edge of the housing making intimate sealing contact with the user's face. A one way exhaust valve is formed on the housing as well as a one way intake port. The intake port can be coupled to an air filter element. A first side of the housing is shaped to receive and nestle the gun stock to permit said side of the housing to rest against the gun stock while the breathing mask is worn on the shooter's face without dislodging the breathing mask from the shooter's face.

### BACKGROUND OF THE INVENTION

Indoor shooting ranges (ISRs) offer a controlled environment where law enforcement personnel and recreation shooters can practice shooting. However, the ventilation systems at ISRs do not provide adequate protection from the health risks associated with inhaling lead fumes when a firearm is discharged.

Outdoor shooting ranges (OSRs) do not provide much better protection from the health risks associated with inhaling lead fumes. OSRs provide no ventilation system to immediately blow away or disperse lead fumes when a firearm is discharged. Dispersion is left to the natural elements of nature such as wind speed and direction. If there is little or no wind, the shooter's personal breathing space may become contaminated. ^{[1]}

Additionally, to the mechanicals of a rifle and where the face of the shooter is during the discharge of the rifle, the inhalation of lead fumes by the shooter is unavoidable. Since the shooter is closest to the point of discharge, the shooter's health is at risk whether a rifle is discharged in an ISR or at an OSR.

The dangers of lead exposure have been well documented and apart from law enforcement personnel and recreation shooters, employees and instructors who work at ISRs are also exposed to lead fumes. ^{[2]}

There are respiratory masks on the market that use particulate and hepa filters that shooters can wear to protect themselves from lead fumes. Use of these masks at ISRs and OSRs is not practical as they would interfere with the shooters' accurate and comfortable use of a firearm. These masks are usually bulky and come in a standard ‘one size fits all.’ They are designed to cover most of the face and would obstruct the shooter's view. These masks would also hit on the butt stock of a rifle when the shooter lowers their cheek and places the butt stock against their shoulder as the rifle is discharged. The shooters' attempts to find a comfortable facial position on the butt stock would cause displacement of the mask, loosening of the strap and create air pockets that would allow the shooter to inhale lead fumes. These are some of the reasons why most shooters do not wear these masks. They interfere with the accurate and comfortable use of a rifle and they are generally not comfortable for long term wear.

An improved breathing mask which permits the shooter to wear the mask while operating a rifle would be advantageous.

### SUMMARY OF THE INVENTION

The present invention is an improved breathing mask for wearing on top of a shooter's nose and mouth on the shooter's face while the shooter is shooting a rifle having a gun stock. The filter mask includes a flexible housing having a nose portion and opposite left and right cheek portions, the nose portion and left and right cheek portions being dimensioned to fit over the user's nose and mouth. The flexible housing has a peripheral edge circumscribing the nose portion and left and right cheek portions. A one way exhaust valve is formed on the flexible housing on one of the left and right cheek portions, the intake port being removably coupleable to an air filter element. A mounting strap for mounting the breathing mask tightly to the shooters face when the breathing mask is worn by the shooter is also provided. The nose portion and the left and right portions are dimensioned such that the peripheral edge snuggly contacts the shooter's face along an entire length of the peripheral edge when the breathing mask is worn by the shooter. Finally, a concave recess is formed on one of the left and right cheek portions which is opposite the cheek portion having the intake port, the concave recess is dimensioned to receive the gun stock to permit said cheek portion to rest against the gun stock while the breathing mask is worn on the shooter's face without dislodging the breathing mask from the shooter's face.

### BRIEF DESCRIPTION OF THE DRAWINGS

FIG. 1 is a perspective view of a filter mask made in accordance with the present invention showing the right side of the filter mask;

FIG. 1a is a perspective view of the filter mask shown in FIG. 1 showing the left side of the filter mask;

FIG. 2 is a front view of a filter mask made in accordance with the present invention where the filter cartridge holder is formed on the right side of the filter mask;

FIG. 2a is a front view of the filter mask shown in FIG. 1;

FIG. 3 is a back view of a mold for forming the filter mask shown in FIG. 2;

FIG. 3a is a back view of a mold for forming the filter mask shown in FIG. 1;

FIG. 3B is an isometric view of a mold for forming the filter mask shown in FIG. 1 being worn by a person so as to conform the filter mask to the person.

FIG. 4 is an isometric view of the filter mask shown in FIG. 1 being worn by a person shooting a rifle while wearing the filter mask.

In the drawings like characters of reference indicate corresponding parts in the different figures.

### DETAILED DESCRIPTION

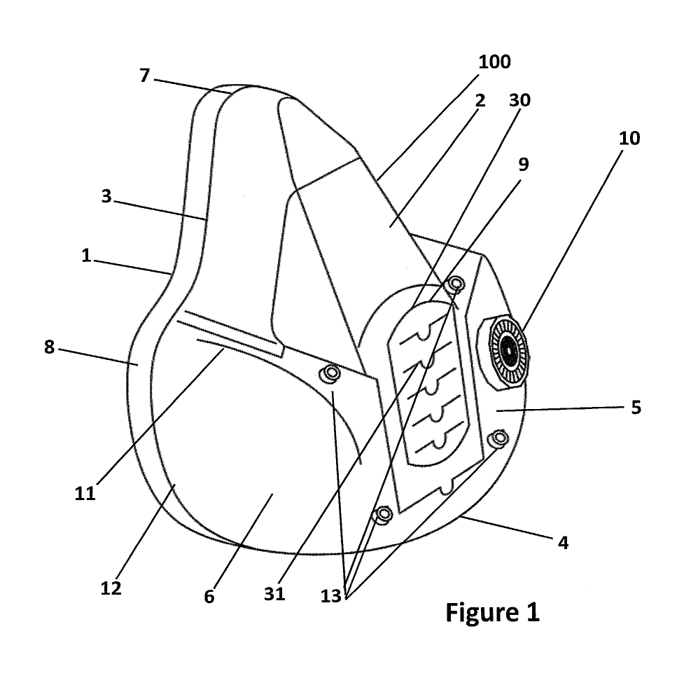

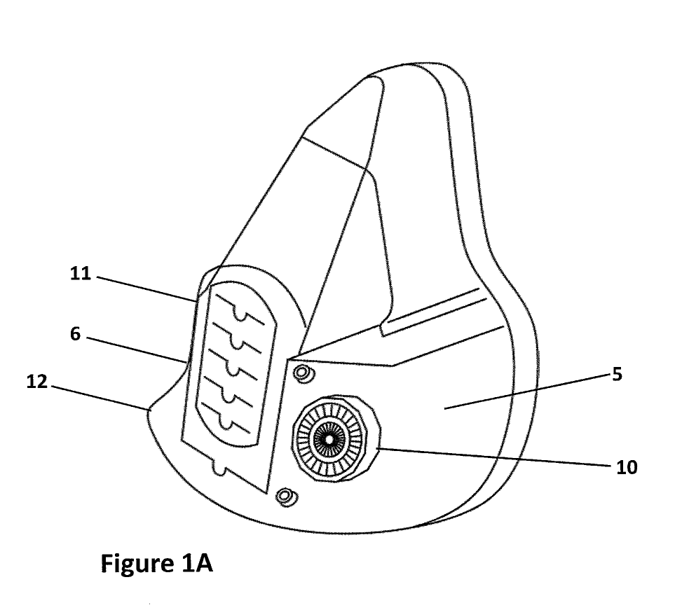

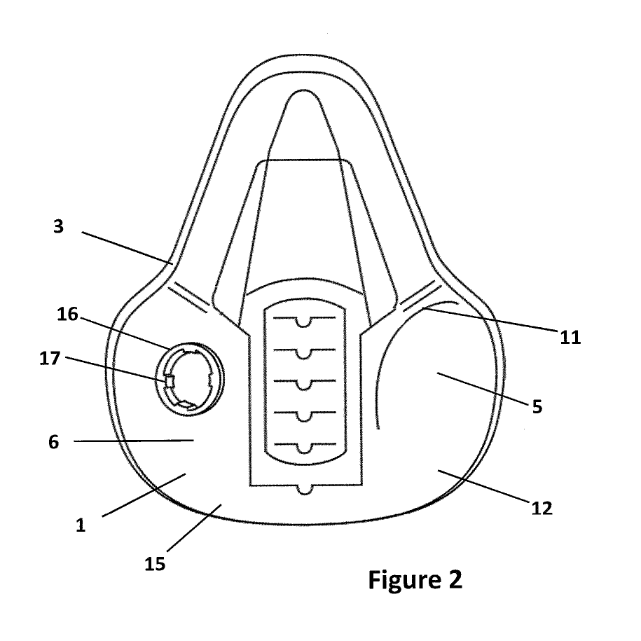

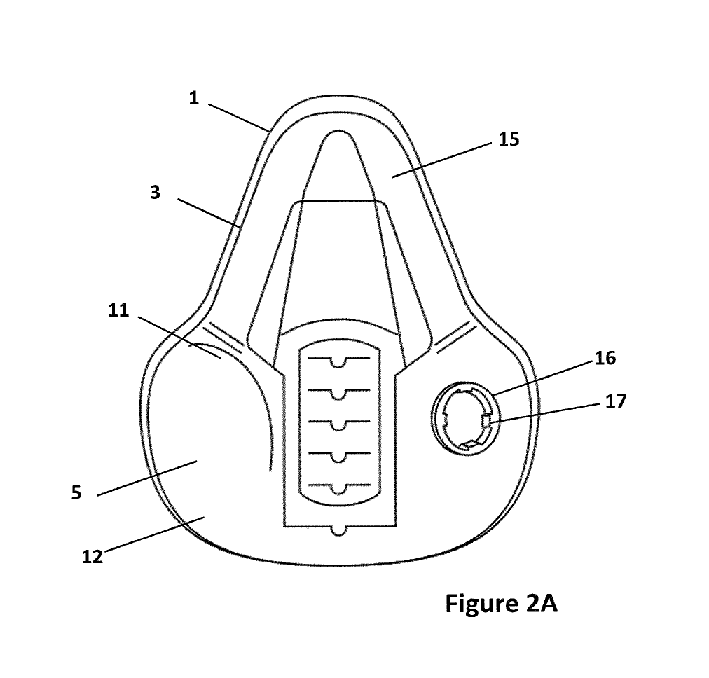

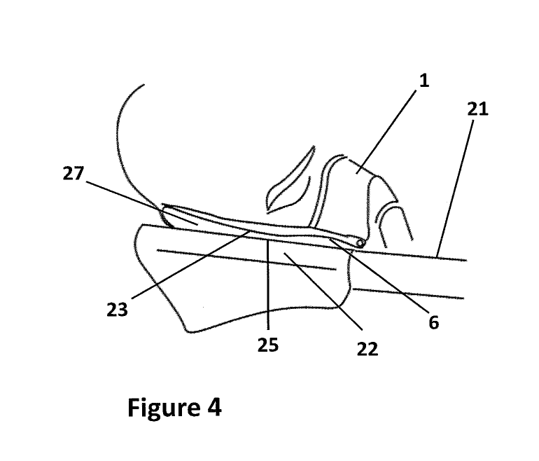

Referring firstly to FIG. 1, a shooting respiratory mask made in accordance with the present invention is shown generally as item 100 and has a mask housing (body) 1 that includes a nose portion 2, chin portion 4, and first (left) and second (right) cheek portions 5 and 6, respectively. Surrounding the mask body (housing 1) is a peripheral edge portion 3 that is preferably customized to each wearer's facial structure, more specifically the bridge of the nose 7, cheeks and chin 4. Peripheral edge portion 3 circumscribes the nose portion, left and right cheek portions and the chin portion and permits close contact with the wearer's face. Peripheral edge portion 3 is preferably sufficiently flexible to maintain close contact with the wearer's face even as the user breathes through the mask. Mask housing (body) 1 is a relatively thin, rigid structural member or insert preferably molded of polypropylene resin while the outer ridge (peripheral) portion 3 is formed using a flexible synthetic resin. Housing 1 has a middle portion 30 which is preferably flat and formed with a central opening (not shown) which contains an exhalation valve (not shown) and exhalation diaphragm (also not shown). The central opening of middle portion 30 is covered by a thin, rigid cap 9 which has grills 31 to enable air to be purged from the mask interior. The first cheek portion 5 is flat and formed with a cheek aperture (not shown) to permit filter cartridge 10 to be snapped into place and prevented from moving. The second cheek portion 6 has a concave surface from the top of the second cheek portion 11 to the bottom of the second check portion 12 to allow the wearer to rest the cheek on a rifle butt stock (see FIG. 4) without interference while maintaining good facial contact to the wearer's face. FIG. 1 shows a shooting respiratory mask for a right handed shooter. If the wearer is left handed, the first cheek portion 5 is curved inwards and the filter cartridge 10 will reside on the second cheek portion 6 (as seen in FIG. 2A). At each corner of the first cheek portion 5 and each corner of the second 6 cheek portion is a harness carriage 13 used to attach a harness (not shown) to the mask body 1. The harness (not shown) may include one adjustable strap that is attached to the harness carriage 13 to assist in supporting the mask body 1 on the face of a wearer. The harness (not shown) may use a buckle that enables open ends of the straps to be secured together.

FIG. 1A shows a shooting respiratory mask configured for a right handed shooter. The second cheek portion 6 is curved inwards (i.e. is concave) from the top of the second cheek portion 11 to the bottom of the second cheek portion 12 to allow the wearer to rest their cheek on a rifle butt stock (not shown) without interference while maintaining good facial contact with the wearer's face. The filter cartridge 10 will reside on the first cheek portion 5.

FIG. 2 shows a mask body 1 and the soft outer ridge portion 3. Mask housing 1 and all the portions that make up mask housing 1 will be molded as one fixed insert 15. The soft outer ridge portion 3 is made of a synthetic resin and will be mechanically interlocked to the fixed insert 15. A filter cartridge holder 16 with three or four notches 17 is used to lock the filter cartridge (not shown) into place.

FIG. 2A. Shows a shooting respiratory mask configured for a left handed shooter. The first cheek portion 5 is curved inwards (i.e. is concave) from the top of the first cheek portion 11 to the bottom of the first check portion 12 to allow the wearer to rest their cheek on a rifle butt stock (not shown) without interference while maintaining good facial contact with the wearer's face. The filter cartridge holder 16 will reside on the second cheek portion 6. As mentioned above, cartridge holder 16 has a plurality of notches 17 for coupling the filter cartridge.

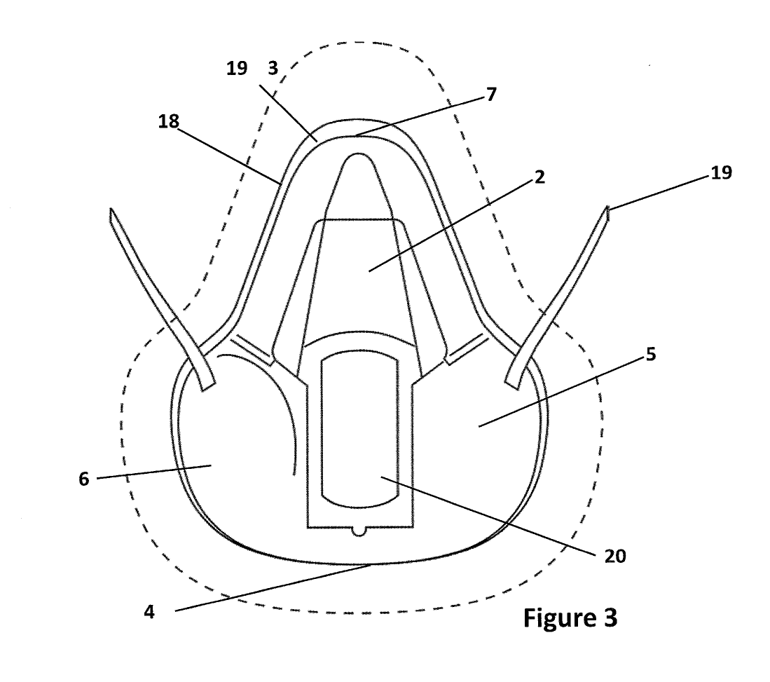

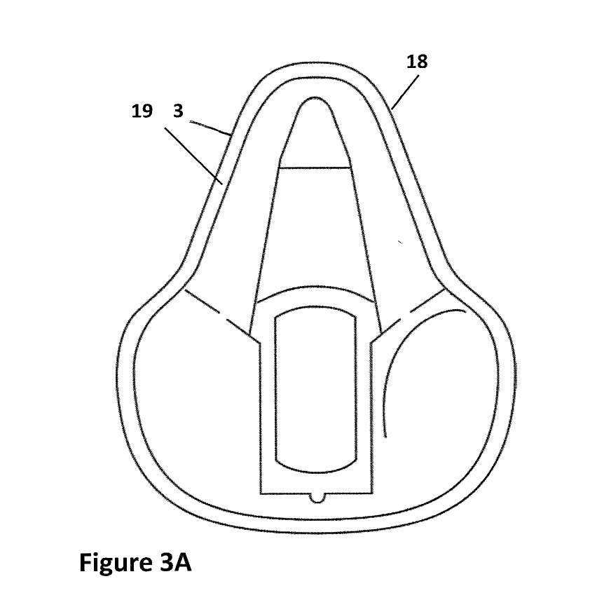

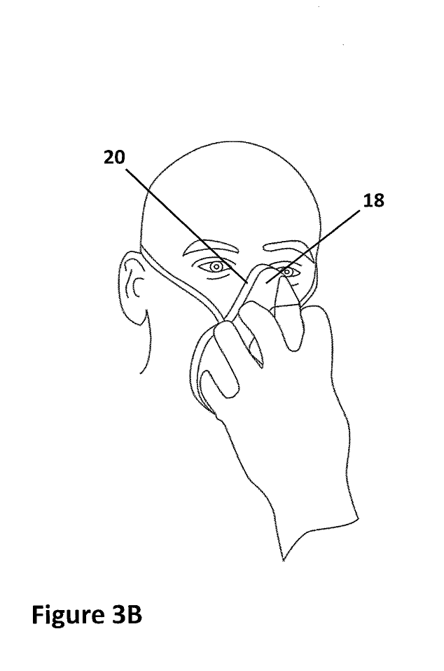

FIGS. 3 through 3B illustrate example devices and steps for use in forming a shooting respiratory mask for the particular wearer. In certain embodiments, one or more of these devices and steps may be used to form a custom mask that is unique to the wearer's facial structure/contour through each step of the forming process to ensure that mask body 1 maintains good facial contact to a wearer's face.

FIG. 3 shows a mask mold 18 which is essentially a negative impression of the shooting respiratory mask minus certain components such as the filter cartridge. Mask mold 18 may include one or more plastics, acrylics, or other appropriate materials. Unlike most respiratory masks which are universally one size fits all, mask mold 18 will be available in at least three sizes (small, medium, large) to account for the wearer's facial size (nose, mouth, cheeks). In FIG. 3, the solid line representation shows mask mold 18 in a small size configuration, whereas phantom line representation illustrates the mask mold 18 configuration in a medium size where the nose portion 2, chin portion 4, first and second cheek portions 5 and 6 respectively and outer ridge portion 3 are larger in width, length and height to account for a wearer's facial size. The wearer will select a mask mold 18 configuration size based on their facial structure and left or right handed configuration. The mask mold 18 is currently configured for a right handed shooter as shown since the second cheek portion 6 is curved inwards while first cheek portion 5 is flat. For left handed shooter configuration, mask mold 18 would have the first cheek portion 5 curved inward and second cheek portion 6 would be flat. In certain embodiments, mask mold 18 may be used together with impression material (not shown) to create an impression of certain unique physical features of the wearer's face. For example, outer ridge portion 3 of the mask mold 18 may represent a tray 19 that may be generally shaped to conform to the nose bridge 7, cheek and chin of wearer's face. A harness 19 is attached to the mask mold and is used by the wearer to help create the impression. The mask mold 18 may include an opening 20 to allow the wearer to breath while creating impression.

FIG. 3A. Shows a view of the back of the mask mold 18 with a tray 19 representing the outer ridge portion 3 of the mask mold 18. Impression material (not shown) may be injected within the tray 18 for use in forming the soft outer ridge portion 3 to conform to the wearer's unique facial contours.

FIG. 3B. Shows a wearer holding the mask mold 18 with impression material 20 to the wearer's face. An interior surface of impression material 20 directly contacts the wearer's face and conforms to the wearer's unique facial contours. Once the impression material 20 has become firm enough to retain the impression of the wearer's facial contours, the impression material 20 together with the mask mold 18 may be removed from the wearer's face.

FIG. 4. Shows a wearer of the customized shooting respiratory mask 1 holding rifle 21 in a shooting position. The second cheek portion 6 with the inward curvature (concave face) allows the wearer to rest the second cheek portion 6 against the rifle's butt stock 22. Essentially portion 25 of rifle butt 22 is nestled inside concave surface 27. This will allow the wearer to look through the rifle's scope (not shown) or fixed iron sights (not shown) at the target without interference from the shooting respiratory mask while maintaining good facial contact 23 to the wearer's face thus reducing the inhalation of lead fumes during discharge of the rifle. Strap 29 helps to keep the mask tight on the shooter's face.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art.

What is claimed is:

1. A breathing mask for wearing on top of a shooter's nose and mouth on the shooter's face while the shooter is shooting a rifle having a gun stock, the filter mask comprising:
a. A flexible housing having a nose portion and opposite left and right cheek portions, the nose portion and left and right cheek portions being dimensioned to fit over the user's nose and mouth, the flexible housing having a peripheral edge circumscribing the nose portion and left and right cheek portions;
b. A one way exhaust valve formed on the flexible housing;
c. A one way intake port formed on one of the left and right cheek portions, the intake port being removably coupleable to an air filter element;
d. The nose portion and the left and right portions being dimensioned such that the peripheral edge snuggly contacts the shooter's face along an entire length of the peripheral edge when the breathing mask is worn by the shooter, and
e. A concave recesses formed the left and right cheek portion opposite the cheek portion having the intake port, the concave recesses dimensioned to receive the gun stock to permit said cheek portion to rest against the gun stock while the breathing mask is worn on the shooter's face without dislodging the breathing mask from the shooter's face.

2. A breathing mask for wearing on top of a shooter's nose and mouth on the shooter's face while the shooter is shooting a rifle having a gun stock, the filter mask comprising:
a. A flexible housing having a nose portion and opposite left and right cheek portions, the nose portion and left and right cheek portions being dimensioned to fit over the user's nose and mouth, the flexible housing having a peripheral edge circumscribing the nose portion and left and right cheek portions;
b. A one way exhaust valve formed on the flexible housing;
c. A one way intake port formed on one of the left and right cheek portions, the intake port being removably coupleable to an air filter element;
d. The nose portion and the left and right portions being dimensioned such that the peripheral edge snuggly contacts the shooter's face along an entire length of the peripheral edge when the breathing mask is worn by the shooter, and
e. One of the left and right cheek portions being configured to receive and nestle a portion of the gun stock to permit said cheek portion to rest against the gun stock while the breathing mask is worn on the shooter's face without dislodging the breathing mask from the shooter's face.

3. The breathing mask of claim 3 wherein said one of the left right cheek portions has a concave face, the concave face configured to receive said portion of the gun stock.

4. A breathing mask for wearing on top of a shooter's nose and mouth on the shooter's face while the shooter is shooting a rifle having a gun stock, the filter mask comprising:
a. A housing dimensioned to fit over the user's nose and mouth, the flexible housing having a peripheral edge circumscribing the housing and making intimate sealing contact with the user's face;
b. A one way exhaust valve formed on the housing;
c. A one way intake port formed on the housing, the intake port being removably coupleable to an air filter element;
d. A first side of the housing being configured to receive and nestle a portion of the gun stock to permit said side of the housing to rest against the gun stock while the breathing mask is worn on the shooter's face without dislodging the breathing mask from the shooter's face.

5. The breathing mask of claim 4 wherein the first side of the housing has a concave surface configured to nestle the portion of the gun stock.

6. The breathing mask of claim 5 wherein the one way intake port is formed on a second side of the breathing mask opposite the first side.
